(19) United States
(12) Patent Application Publication
(10) Pub. No.: US 2024/0272678 A1
(43) Pub. Date: Aug. 15, 2024

(54) LAPTOP MOUNTING PLATE, DEVICE FOR FIXING A CABLE ON THE PLATE, AND SCREW CONNECTING THE PLATE AND THE DEVICE

(71) Applicant: CALIPSO LLC, Oakland, CA (US)

(72) Inventor: Aleksandr MALIKOV, Santa Monica, CA (US)

(21) Appl. No.: 18/109,360

(22) Filed: Feb. 14, 2023

(51) Int. Cl. G06F 1/16; F16M 13/02

(52) U.S. Cl. CPC G06F 1/1656; F16M 13/02

(57) ABSTRACT

The invention relates to auxiliary equipment of a workplace provided with a laptop. The technical result consists in increasing efficiency by improving the cooling of the laptop, simplifying the attachment of a laptop mounting plate to a tripod head without having to use additional elements, reducing the weight of the plate, and reducing the complexity of laying and fixing functional cables. The technical result is achieved by that the laptop fixation plate is made of a lightweight durable material, rectangular shape, and has holes for attaching accessories and ventilation. At least one longitudinal hole is made along one of the long sides of the plate. Slit-like cutouts are made in the middle part of the smaller sides of the plate. In the central part of the plate, there are two symmetrical holes with a partition therebetween. The partition is configured to be fastened to the tripod head.

### FIELD OF THE INVENTION

The invention relates to auxiliary equipment of a workplace provided with a laptop and may be used, for example, in photo and video shooting, music production, as well as in optimizing work with the laptop while standing.

Disclosed is a plate on which a laptop may be mounted, a device for fixing wires on the plate, and a screw connecting the plate to the device.

### BACKGROUND OF THE INVENTION

Working with a laptop for photo and video shooting, music production involves using the laptop, among others, outdoors and while standing.

The stable placement of the laptop on any surfaces is very problematic. This is because wires, for example, of a photo camera, are attached to the laptop, and when a photographer moves while working with a model, either the wire jumps out of a corresponding laptop socket or the laptop itself is pulled off the placement surface.

The prior art discloses a laptop mounting plate which is made of an aluminum alloy, rectangular in shape, and has a single oval-like hole serving as a carrying handle and multiple ventilation holes. The disadvantages of this plate are as follows: the poor cooling of the laptop due to the small size of the ventilation holes, the need for an additional element for attaching the plate to a tripod head, the absence of holes for functional cables, and the large weight of the plate.

The prior art also discloses a laptop mounting plate which is made of an aluminum alloy, rectangular in shape, and has several oval holes along the long side of the plate and multiple ventilation holes. Oval-like holes are made in the middle part of the smaller sides of the plate. The disadvantages of this plate are as follows: the poor cooling of the laptop due to the small size of the ventilation holes, the need for an additional element for attaching the plate to the tripod head, the large weight of the plate, and holes for functional cables are closed and do not allow free passage of the cables without disconnecting them from the laptop.

### SUMMARY OF THE INVENTION

The objective of the invention is to eliminate the above-indicated disadvantages of the prior art.

When implementing the above-indicated objective, a technical result is achieved, which consists in increasing efficiency by improving the cooling of a laptop, simplifying the attachment of a laptop mounting plate to a tripod head without having to use additional elements, reducing the weight of the plate, and reducing the complexity of laying and fixing functional cables, as well as simplifying the holding of the plate during transportation.

The technical result is achieved by that the laptop mounting plate is made of a lightweight durable material, rectangular in shape, and has holes for attaching accessories and ventilation. According to the invention, at least one longitudinal hole is made along one of long sides of the plate, and slit-like cutouts are made in the middle part of smaller sides of the plate. Furthermore, two symmetrical holes are made in the central part of the plate with a partition therebetween. The partition is configured to be fastened to the tripod head.

The lightweight durable material is an aluminum alloy, a magnesium alloy, a composite material, an engineering plastic or any other material having desired characteristics.

The plate has overall dimensions of 437.5 mm by 278.57 mm and a thickness of 6.35 mm.

The number of the longitudinal holes in the upper part of the plate may be three or five.

The two holes in the central part of the plate may be made oval.

Furthermore, the technical result is achieved by a device for fixing a cable on the laptop mounting plate, which is made of a lightweight durable material and configured as a rectangular mandrel having rubber stops arranged in the corners thereof. In the meantime, U-shaped cutouts are made on smaller sides of the mandrel from the side of the rubber stops, and the middle parts of large sides of the mandrel are connected by a partition having a hole for a fastening screw.

The lightweight durable material of the device is an aluminum alloy, a magnesium alloy, a composite material, an engineering plastic or any other material having desired characteristics.

The device has overall dimensions of 70 mm by 38.11 mm and a thickness of 10 mm.

Additionally, the technical result is achieved by a screw for fastening the above-indicated device to the above-indicated plate. The screw is made of steel and comprises a rod having an external thread and a cylindrical head. The head has a slot for a flat working tool. Protrusions for manual screwing and unscrewing are made perpendicular to the slot.

The screw has a length of 14.35 mm, and the rod has a length of 7.5 mm and a thread length of 3.9 mm.

### BRIEF DESCRIPTION OF THE DRAWINGS

The essence of the invention is illustrated in FIGS. 1-5C, where:

FIG. 1 shows an axonometric view of a laptop mounting plate (the plate is denoted by reference sign 1);

FIG. 2 shows an enlarged view of area A from FIG. 1 (a device for fixing a cable on the plate is denoted by reference sign 2);

FIG. 3 shows a top side view of the plate with all dimensions indicated;

FIG. 4 shows an axonometric view of the device for fixing the cable on the laptop mounting plate (reference signs indicate the following elements: 1—a fastening screw, 2—the device for fixing the cable, 3—rubber stops);

FIG. 5A-5C shows axonometric, front and side views of the fastening screw correspondingly.

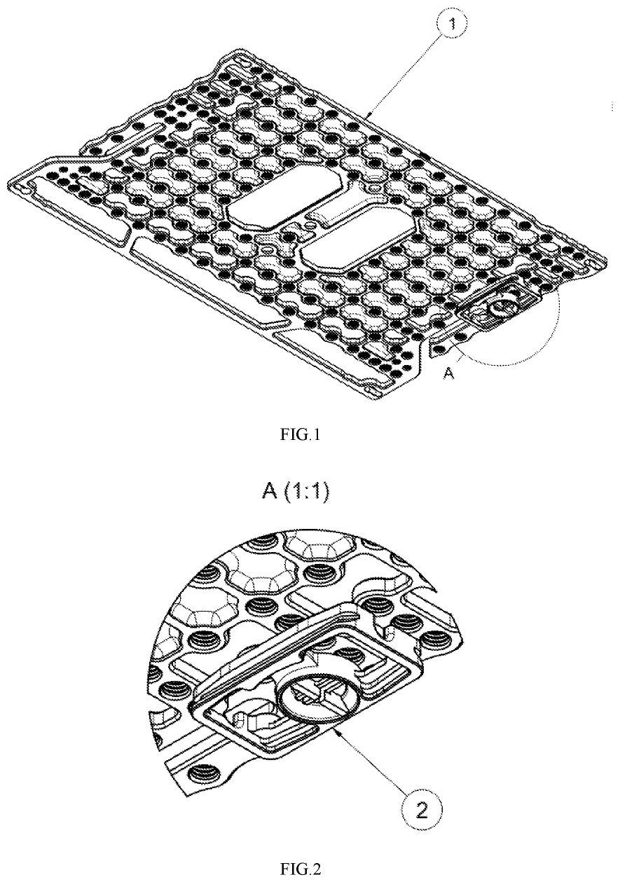

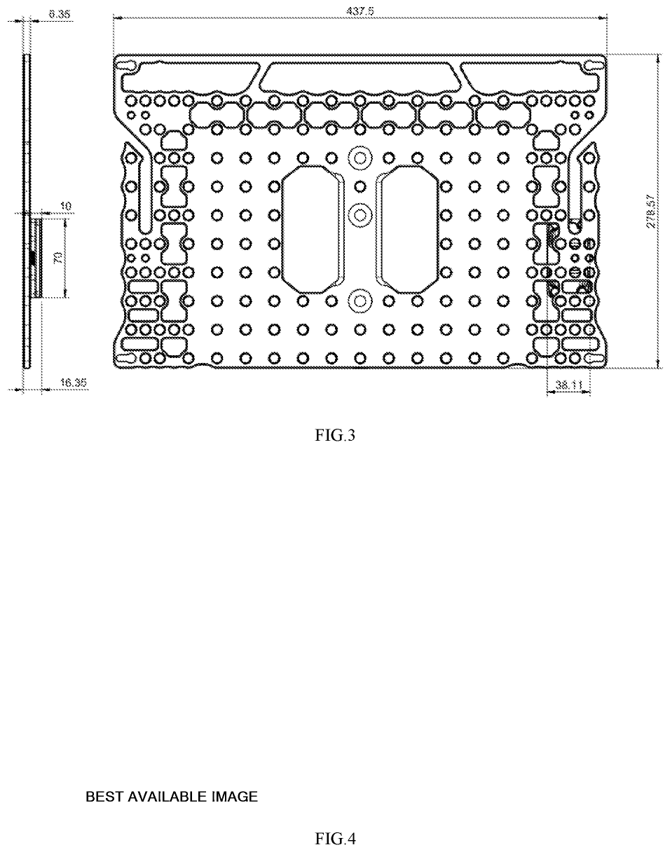

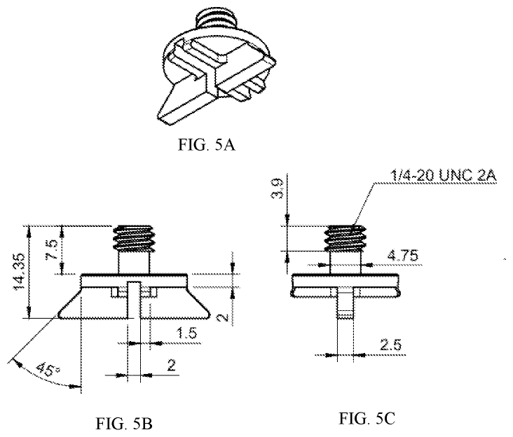

### DETAILED DESCRIPTION OF THE INVENTION

The invention is the basis for organizing work with a laptop. All kinds of accessories are attached to a laptop mounting plate, such as: fasteners (clamps) of the laptop itself that ensure its rigid fixation on the surface of the plate, professional batteries that ensure independence from a power outlet, a “tent” that protects the laptop against precipitation and sun (there are special mounting seats for fixing it), external hard drives, wire clamps, etc.

The essence of the plate is that the mount to a tripod head is integrated into the plate itself. The prior art says nothing about this mount—to fix such plates on a tripod, it is necessary to use an additional element, i.e., a tripod platform.

Furthermore, the plate has slit-like cutouts in its left and right parts. These cutouts are multifunctional, but most often used for quick organization/fixation of wires (usually connecting a photo camera to the laptop).

In addition, the distinctive feature of the invention is the whole range of technical solutions that reduce the weight of the product to a minimum, namely: the abundance of “pockets” in the lower part of the plate, the wavy shape of the edges of the plate and the wavy internal structures of the plate, as well as fitting threaded holes. Moreover, the plate is made with wavy cutouts which reduce the likelihood of the plate slipping out of user hands during its transportation and are also a technical solution that reduces the weight of the product, since they are as close as possible to the threaded holes. Also, the wavy edges form the unique and recognizable design of the product.

The invention is characterized by that “the holes are flown around with a material”. This is a technological solution that most clearly manifests itself in the area under a handle and looks like the holes are hanging in the air with a minimum of material around them. This is not only a design solution that gives the product a special, recognizable appearance, but also effectively reduces the weight of the product. There is a philosophy “I cut off everything superfluous”, and in this case the approach “I add only when absolutely necessary” is applied—the holes cannot hang in the air, they need a minimum amount of material to be implemented.

Furthermore, the continuation of this design philosophy can be found in a less expressive form, but nevertheless, in the areas near the cutouts for the wires (the wavy edge of the product) and in the front. These “waves” reduce additional few grams and, moreover, have a positive effect on the tactile component of interaction with the product. By using these “waves”, the product is less likely to slip out of the user hands.

The distinctive feature of the plate is the presence of through slots that provide unhindered intake and exhaust of air from the corresponding ventilation holes of MacBook laptops.

A device for fixing a cable on the plate performs the function of fixing the cable connecting the laptop to the photo camera.

The cable is firmly fixed with this device. Moreover, being a removable element, such a device may be attached both to the left and to the right of the laptop, depending on which port is closer to a photographer.

A fastening screw is designed such that it may be tightened by fingers without having to use a screwdriver/wrench or, for example, a coin (replacing the screwdriver).

The proposed designs of the plate, the device for fixing the cable and the screw connecting them make it possible to eliminate the disadvantages of the prior art, thereby allowing one to achieve the technical result that consists in increasing efficiency by improving the cooling of the laptop, simplifying the attachment of the plate to the tripod head without having to use additional elements, reducing the weight of the plate, and reducing the complexity of laying and fixing functional cables.

The search conducted by using publicly available information sources has showed that the whole set of features of the present invention is unknown and unobvious from the prior art. Therefore, the invention meets the patentability requirements of “novelty” and “inventive step”.

The present invention is manufactured from standard materials in this field of technology by using well-known equipment. In other words, it can be used in industry, for which reason the invention meets the patentability requirement of “industrial applicability”.

Upon considering the above description with an exemplary embodiment of the invention, other changes, modifications and embodiments of the invention will become apparent to a skilled artisan. Thus, all such changes, modifications and embodiments, as well as other areas of use that do not depart from the essence of the present invention, should be considered to be within the scope of the appended claims.

1. A laptop mounting plate made of a lightweight durable material, rectangular in shape and having holes for attaching accessories and ventilation, wherein the plate has at least one longitudinal hole along one of long sides of the plate, slit-like cutouts in a middle part of smaller sides of the plate, and two symmetrical holes in a central part of the plate, and wherein there is a partition between the two symmetrical holes, the partition being configured to be fastened to a tripod head.

2. The plate of claim 1, wherein the lightweight durable material is an aluminum alloy, a magnesium alloy, a composite material, or an engineering plastic.

3. The plate of claim 1, wherein the plate has overall dimensions of 437.5 mm by 278.57 mm and a thickness of 6.35 mm.

4. The plate of claim 1, wherein the plate has an upper part having three or five longitudinal holes.

5. The plate of claim 1, wherein the two symmetrical holes in the central part of the plate are made oval.

6. A device for fixing a cable on the laptop mounting plate of claim 1, wherein the device is made of a lightweight durable material and configured as a rectangular mandrel having rubber stops arranged in the corners thereof, and wherein U-shaped cutouts are made on smaller sides of the mandrel from the side of the rubber stops, and middle parts of large sides of the mandrel are connected by a partition having a hole for a fastening screw.

7. The device of claim 6, wherein the lightweight durable material is an aluminum alloy, a magnesium alloy, a composite material, or an engineering plastic.

8. The device of claim 6, wherein the device has overall dimensions of 70 mm by 38.11 mm and a thickness of 10 mm.

9. A screw for fastening the device of claim 6 to the plate of claim 1, wherein the screw is made of steel and comprises a rod having an external thread and a cylindrical head, wherein the head has a slot for a flat working tool, and protrusions for manual screwing and unscrewing are made perpendicular to the slot.

10. The screw of claim 9, wherein the screw has a length of 14.35 mm, and the rod has a length of 7.5 mm and a thread length of 3.9 mm.
